(19) United States
(12) Patent Application Publication
(10) Pub. No.: US 2022/0294053 A1
(43) Pub. Date: Sep. 15, 2022

(54) METAL-AIR BATTERY

(71) Applicant: SHARP KABUSHIKI KAISHA, Sakai City (JP)

(72) Inventors: FUMITOSHI SUGINO, Sakai City (JP); HIROYUKI HIRAKAWA, Sakai City (JP); HIROTAKA MIZUHATA, Sakai City (JP)

(21) Appl. No.: 17/672,170

(22) Filed: Feb. 15, 2022

(30) Foreign Application Priority Data
Mar. 11, 2021 (JP) 2021-038911

(51) Int. Cl. H01M 12/08; H01M 4/86

(52) U.S. Cl. CPC H01M 12/08; H01M 4/86; H01M 2004/027

(57) ABSTRACT

A metal-air battery includes a metal negative electrode, an air electrode, and a spacer interposed between the metal negative electrode and the air electrode 5. The spacer is composed of grip-shaped frameworks extended in a three-dimensional direction, and an electrolytic solution for filling a space between the frameworks.

### BACKGROUND OF THE INVENTION

### Field of the Invention

The present invention relates to a metal-air battery having a metal negative electrode and a positive electrode.

### Description of the Background Art

In conventional metal-air batteries, a spacer has been sometimes placed between a negative electrode and a charging electrode or between a negative electrode and an air electrode in order to store an electrolytic solution in a reaction space to improve a battery performance (e.g. see JP 2017-224383 A).

The metal-air battery described in JP 2017-224983 A includes a negative electrode, an ion migration layer, and a positive electrode separated from the negative electrode via the ion migration layer. A spacer is inserted into this metal-air battery for maintaining a shape of a joint composed of the ion migration layer and the negative electrode in some cases, and a material of the spacer can be exemplified by a porous material.

The air secondary battery described in JP 2020-126754 A has an electrode group including an air electrode and a negative electrode which are piled with a separator interposed therebetween, and a container containing the electrode group together with an alkaline electrolytic solution. A material adopted for the separator can be exemplified by a polyamide fiber non-woven fabric.

In the aforementioned metal-air battery, a porous material or a non-woven fabric is used as a spacer, but the metal-air battery has a problem of increased resistance because a pathway through which the electrolytic solution passes is intricate.

Incidentally, when the charge/discharge reaction was repeated, the reaction active substance expanded, resulting in deformation of the negative electrode in some cases. In some spacers, a central portion corresponding to a position of a reaction field is hollow, and therefore such a spacer has had a problem that shape deformation (shape change) of the negative electrode cannot be suppressed.

The present invention is made to solve the aforementioned problems, and an object of the present invention is to provide a metal-air battery capable of suppressing the shape deformation of the negative electrode while securing a space for the electrolytic solution.

### SUMMARY OF THE INVENTION

The metal-air battery according to the present invention includes a metal negative electrode, a positive electrode, and a spacer interposed between the metal negative electrode and the positive electrode. The spacer is characteristically composed of grid-shaped frameworks extended in a three-dimensional direction, and an electrolytic solution that fills spaces between the frameworks.

The metal-air battery according to the present invention may be configured such that the spacer has through holes that penetrate the spacer in a thickness direction in which the metal negative electrode and the positive electrode are opposed to each other.

The metal-air battery according to the present invention may be configured such that the size of the through holes changes in the thickness direction.

The metal-air battery according to the present invention may be configured such that the size of the through holes is smaller on the metal negative electrode side and larger on the positive electrode side.

The metal-air battery according to the present invention may be configured such that the spacer is composed of first frameworks and second frameworks which have mutually different grid intervals, and the grid interval between the first frameworks is twice or more integer times as large as the grid interval between the second frameworks.

The metal-air battery according to the present invention may be configured such that the frameworks are periodically arranged in a surface direction along a surface in contact with the metal negative electrode and in the thickness direction.

The metal-air battery according to the present invention may be configured such that the frameworks have a thickness of 0.5 to 2 mm.

The metal-air battery according to the present invention may be configured such that each cell comparted by the frameworks has a volume of 30 to 100 mm³.

The metal-air battery according to the present invention may be configured such that the spacer has a thickness of 1.5 to 5 mm.

The metal-air battery according to the present invention may be configured such that the metal negative electrode has a thickness of 1 mm or larger, and the thickness of the spacer is 0.75 or more times larger than the thickness of the metal negative electrode.

The metal-air battery according to the present invention may be configured such that a separator is interposed between the metal negative electrode and the spacer, and a ratio of the thickness of the separator to the grid interval between the frameworks is 0.05 to 0.09.

The metal-air battery according to the present invention may be configured such that a surface opposed to the metal negative electrode is sandwiched by a pair of fixtures.

According to the present invention, installation of the spacer makes it possible to secure the space for the electrolytic solution so that substances can migrate smoothly inside the battery while suppressing the shape deformation (shape change) caused by the reaction of the metal negative electrode.

### BRIEF DESCRIPTION OF THE DRAWINGS

FIG. 1 is a schematic cross-sectional view of a metal-air battery according to the first embodiment of the present invention.

FIG. 2 is a schematic cross-sectional view of a conventional metal-air battery.

FIG. 3 is a schematic front view of a spacer in the metal-air battery according to the first embodiment of the present invention.

FIG. 4 is a schematic front view of a spacer in Modification Example 1.

FIG. 5 is a schematic front view of a spacer in Modification Example 2.

FIG. 6 is a schematic front view of a spacer in Modification Example 3.

FIG. 7A is a schematic front view of a spacer according to the second embodiment of the present invention.

FIG. 7B is a schematic cross-sectional view of the spacer illustrated in FIG. 7A.

FIG. 8 is a table of properties presenting results of Experiment 1.

FIG. 9 is a table of properties presenting results of Experiment 2.

FIG. 10 is a table of properties presenting results of Experiment 3.

### DESCRIPTION OF THE PREFERRED EMBODIMENTS

### First Embodiment

A metal-air battery according to the first embodiment of the present invention will be explained below with reference to the figures.

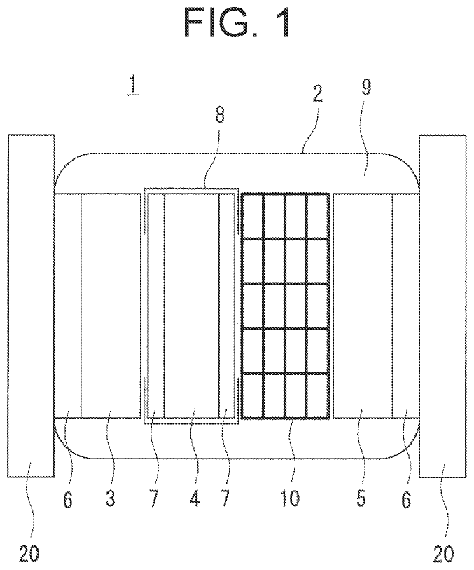

FIG. 1 is a schematic cross-sectional view of a metal-air battery according to the first embodiment of the present invention.

A metal-air battery 1 according to the first embodiment of the present invention is a three-electrode metal-air secondary battery which is configured such that a metal negative electrode 4 is sandwiched between a charging electrode 3 and an air electrode 5 (positive electrode). The metal-air battery 1 is e.g. a zinc-air battery, a lithium-air battery, a sodium-air battery, a calcium-air battery, a magnesium-air battery, an aluminum-air battery, a ferrous-air battery, or the like. An inside of the metal-air battery 1 is filled with an electrolytic solution 9, and a packaging material 2 wraps the metal-air battery 1 to maintain a sealing performance.

The charging electrode 3 and the air electrode 5 each face an interior surface of the packaging material 2 through a water repellent film 6, and the packaging material 2 has openings on positions each corresponding to the charging electrode 3 and the air electrode 5 to allow only air to pass therethrough.

The air electrode 5 has an air electrode catalyst and is configured to be a porous electrode as a discharge positive electrode. In an example where an alkaline aqueous solution is used as an electrolytic solution, the air electrode 5 undergoes a discharge reaction, in which water supplied from the electrolytic solution or the like, oxygen gas supplied from the atmosphere, and electrons react on the air electrode catalyst to generate hydroxide ions.

The charging electrode 3 is a porous electrode made of an electron-conductive material. When the alkaline aqueous solution is used as the electrolytic solution, the charging electrode 3 undergoes a charging reaction in which oxygen, water, and electrons are generated from the hydroxide ions.

In the metal negative electrode 4, surfaces on the charging electrode 3 side and the air electrode 5 side are covered with a separator 7. In addition, the metal negative electrode 4 and the separator 7 are covered with a PE bag 8 (polyethylene bag), and the PE bag 8 has an opening.

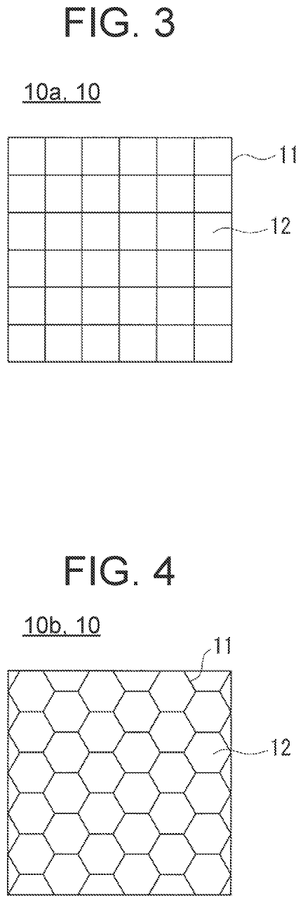

A spacer 10 is disposed between the metal negative electrode 4 and the air electrode 5. The spacer 10 is composed of grip-shaped frameworks 11 extended in a three-dimensional direction and an electrolytic solution for filling spaces between the frameworks 11. A shape of the frameworks 11 will be explained in detail with reference to FIG. 3 described later. The spacer 10 is desirably a substance nonreactive with the electrolyte of the battery. When the electrolyte is a strong alkaline electrolytic solution, the spacer 10 is an alkali-resistant resin, and specific examples of the resin include polyethylene, polypropylene, ABS resin, PTFE resin, and the like. When the negative electrode and the positive electrode are in contact with the spacer 10 made of a metal, electrification is caused inside the battery, resulting in a short circuit, and therefore the metal is not applicable.

The metal-air battery 1 may be configured such that the surface opposed to the metal negative electrode 4 is sandwiched by a pair of fixtures 20. Even if the pressure is suppressed by the spacer 10, a pressure generated by the shape change of the metal negative electrode 4 is pushed back to the opposite side, and the battery expands. Thus, the battery is sandwiched by the fixtures 20, so that the expansion of the battery itself can be suppressed.

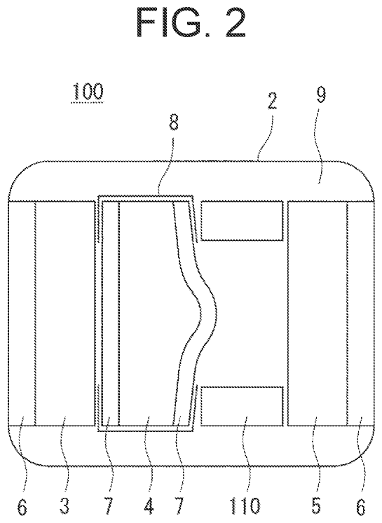

Next, a conventional metal-air battery will be explained with reference to FIG. 2 for comparison with the metal-air battery 1 according to the first embodiment of the present invention.

FIG. 2 is a schematic cross-sectional view of a conventional metal-air battery.

Compared to the first embodiment, the conventional metal-air battery (conventional battery 100) has a frame-shaped support 110 instead of the spacer 10. This frame-shaped support 110 is disposed only on an outer periphery on a surface opposed to the metal negative electrode 4 and the air electrode 5, and has a space through which the electrolytic solution 9 passes, provided on an opened central part. In a metal-air battery, the metal negative electrode 4 expands by the reaction, resulting in shape deformation (shape change) in some cases. At this time, the shape change of the metal negative electrode 4 cannot be suppressed and a part of the metal negative electrode 4 expands so as to enter a cavity of the frame-shaped support 110 as illustrated in FIG. 2, because the central part is hollow on the surface opposed to the metal negative electrode 4 in the frame-shaped support 110. Thereby, a space for the electrolytic solution becomes narrow, and the distance to the air electrode 5 changes, leading to deteriorated battery performance.

In contrast, in the first embodiment, the shape change due to the reaction of the metal negative electrode 4 is suppressed by using the spacer 10 having the grid-shaped frameworks 11. Next, the structure of the spacer 10 in the first embodiment will be explained in detail with reference to FIG. 3.

FIG. 3 is a schematic front view of a spacer in the metal-air battery according to the first embodiment of the present invention.

FIG. 3 illustrates a view of a surface of the spacer 10 (first spacer 10a), which is in contact with the metal negative electrode 4. On the surface in contact with the metal negative electrode 4, through holes 12 are formed by the plurality of frameworks 11 arranged at predetermined intervals and aligned in the vertical and horizontal directions. In the first embodiment, the through hole 12 is formed into a square viewed from the side of the metal negative electrode 4. In FIG. 3, the spacer 10 is schematically illustrated, in which the numbers of the frameworks 11 and the through holes 12 are omitted, but in the actual structure, the numbers of the frameworks 11 and the through holes 12 may be appropriately adjusted depending on the size of the spacer 10. Additionally, in the spacer 10, the frameworks 11 are aligned at intervals also in the thickness direction in which the metal negative electrode 4 and the air electrode 5 are opposed to each other, as illustrated in FIG. 1. In this way, by providing the spacer 10, the space for the electrolytic solution can be secured so that substances can migrate smoothly inside the battery while suppressing the shape deformation (shape change) caused by the reaction of the metal negative electrode 4. In addition, by providing the through holes 12 that penetrates the spacer 10 in the thickness direction in which the metal negative electrode 4 and the air electrode 5 are opposed to each other, the pathway through which the electrolytic solution 9 passes is not intricate, substances smoothly migrate in the thickness direction, and the battery reaction can be enhanced.

As described above, the frameworks 11 are periodically arranged in a surface direction along the surface in contact with the metal negative electrode 4 and in the thickness direction. In this way, the frameworks 11 are arranged in the periodic pattern, so that uniform pressure can be applied to the surface of the metal negative electrode 4 in contact with the spacer 10, therefore thorough pressing can be achieved, and the shape change can be more suppressed.

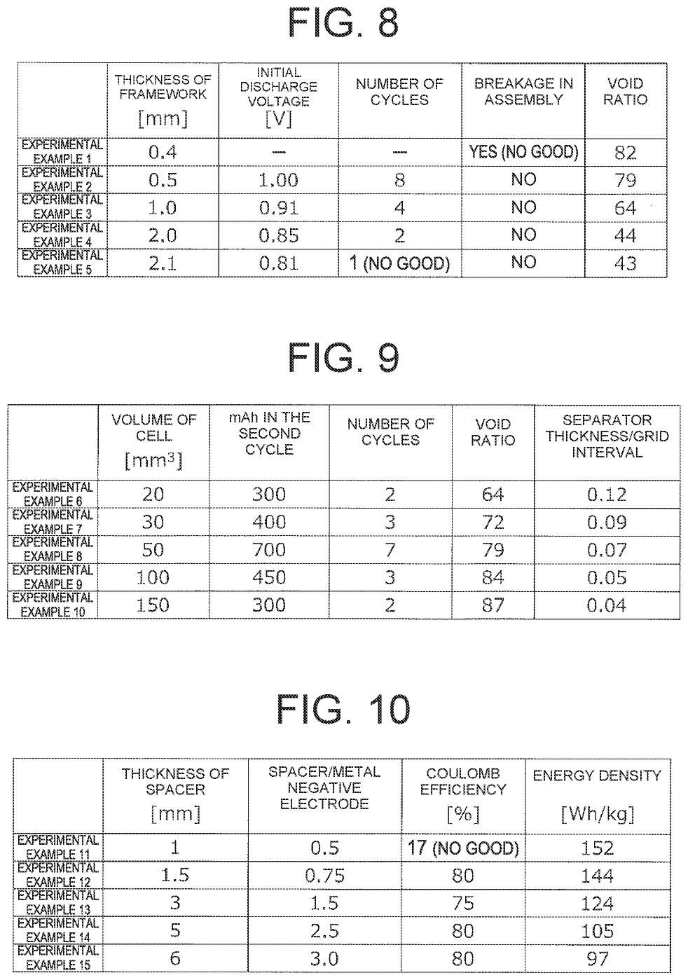

In relation to the spacer 10, various parameters such as the thickness of the spacer 10, the thickness of the framework 11, and the size of the through hole 12 are set to appropriate values, so that deterioration of the battery performance can be suppressed more effectively. The experimental results obtained by examining the various parameters of the spacer 10 will be explained with reference to FIG. 8 to FIG. 10 described below.

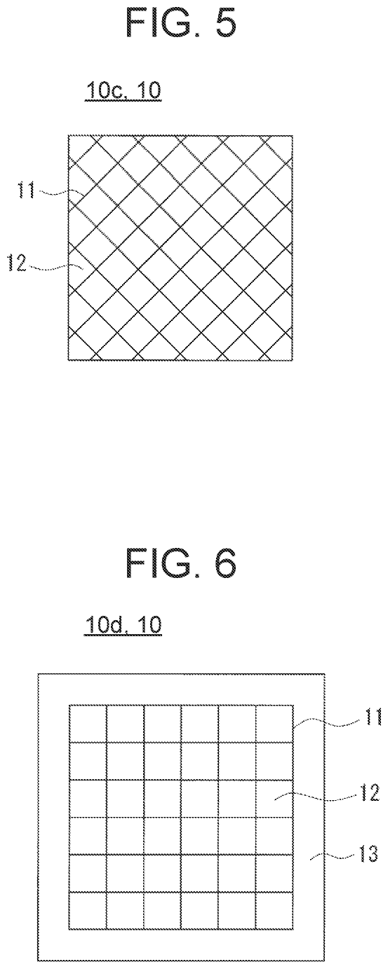

Next, Modification Examples 1 and 2 having different shapes of the through holes 12 will be explained with reference to FIG. 4 and FIG. 5.

FIG. 4 is a schematic front view of a spacer in Modification Example 1.

In Modification Example 1 (second spacer 10b), the through holes 12 are formed into a hexagon viewed from the side of the metal negative electrode 4. That means, a honeycomb structure in which the plurality of hexagonal through holes 12 are combined is formed.

FIG. 5 is a schematic front view of a spacer in Modification Example 2.

In Modification Example 2 (third spacer 10c), the through holes 12 are formed into a rhombus viewed from the side of the metal negative electrode 4. That means, the frameworks 11 are inclined with respect to the perpendicular line to the contact surface with the electrode and are arranged such that the frameworks 11 extending in a straight line intersect each other, and therefore a rhombus-shaped through holes 12 are formed.

Next, Modification Example 3 in which a frame is provided on a margin portion will be explained with reference to FIG. 6.

FIG. 6 is a schematic front view of a spacer in Modification Example 3.

In Modification Example 3 (fourth spacer 10d), a frame 13 is provided on a margin portion. In this way, the margin portion is firmly reinforced by installing the frame 13, while voids are provided by constituting the central framework portion with the frameworks 11 to secure the spaces for the electrolytic solution. The frame 13 plays a role of protecting the central framework portion from physical impacts applied from outside the battery.

### Second Embodiment

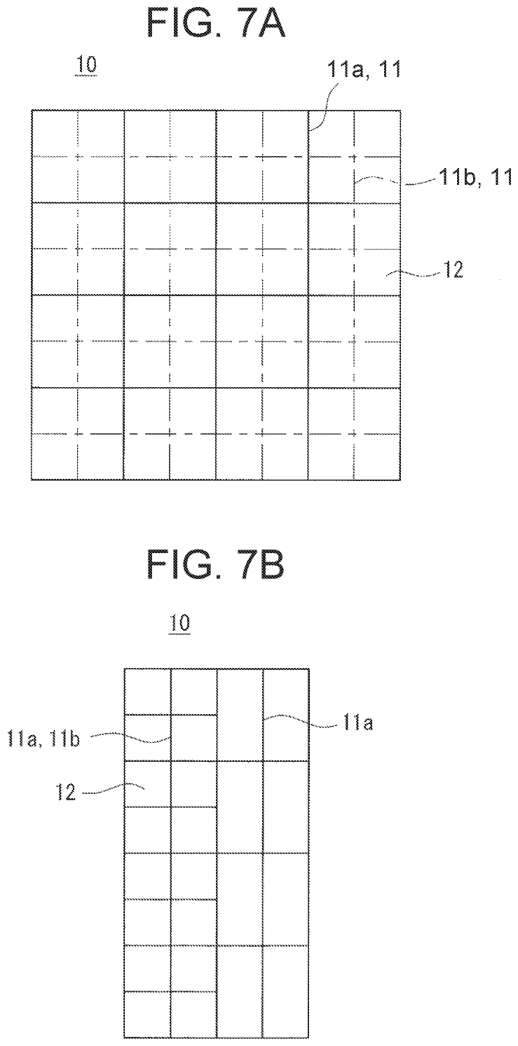

Next, the second embodiment in which through holes 12 having different sizes are provided will be explained with reference to FIG. 7.

FIG. 7A is a schematic front view of a spacer according to the second embodiment of the present invention, and FIG. 7B is a schematic cross-sectional view of the spacer illustrated in FIG. 7A.

The second embodiment is configured such that two types of frameworks 11 (first frameworks 11a and second frameworks lib) are provided, and thereby a size of the through holes 12 on the metal negative electrode 4 side is different from a size of the through holes 12 on the air electrode 5 side. In FIG. 7A, the first frameworks 11a are represented by solid lines and the second frameworks lib are represented by dot-dash-lines for distinguishing between the first frameworks 11a and the second frameworks lib. In the second embodiment, on the side of the metal negative electrode 4 (left side in FIG. 7B), the through holes 12 are composed of the first frameworks 11a and the second frameworks lib, and on the side of the air electrode 5 (right side in FIG. 7B), the through holes 12 are composed only of the first frameworks 11a. The first frameworks 11a constitute larger through holes 12, and the second frameworks 11b are located between adjacent first frameworks 11a. In addition, a grid interval between the first frameworks 11a is twice or more integer times as large as a grid interval between the second frameworks lib. That means, the second frameworks lib divide the through hole 12 formed by the first frameworks 11a into a plurality of through holes to form the smaller through holes 12. When the spacer 10 is viewed from the metal negative electrode 4 side, the first frameworks 11a on the metal negative electrode 4 side and the first frameworks 11a on the air electrode 5 side overlap with each other, so that loss of a void ratio can be reduced.

The spacer 10 is not limited to the aforementioned configuration, and the size of the through holes 12 may be changed by changing the interval between the frameworks 11 depending on the position of the spacer in the thickness direction. Specifically, on the metal negative electrode 4 side, the frameworks 11 are densely aligned to decrease the size of the through holes 12, and on the air electrode 5 side, the frameworks 11 are roughly aligned to increase the size of the through holes 12. In this way, various properties can be obtained by varying the size of the through holes 12. For example, when the through holes 12 are made smaller, a dense structure for tolerating a pressure due to the shape change can be made, and when the through holes 12 are made larger, the spaces for the electrolytic solution become wider to enhance the migration of the substances.

In the second embodiment, since the shape change occurs on the negative electrode side, it is desirable to decrease the size of the through holes 12 on the negative electrode side from the viewpoint of suppressing expansion of the compartments inside the frameworks 11. However, if the size of the through holes 12 is decreased throughout the thickness of the spacer 10, the area occupied by the frameworks 11 increases with respect to the cross section perpendicular to the thickness direction. Thus, an opening ratio decreases, and there is a harmful influence that migration of the substances in the spacer 10 is inhibited. Consequently, it is more desirable to increase the size of the through holes 12 on the air electrode 5 side.

### Experimental Results

In an experiment for the metal-air battery 1 according to the present invention, a zinc-air battery that is a type of the metal-air battery 1 was prepared. The metal negative electrode 4 of the zinc-air battery was made of ZnO, and a metal current collector held 7.5 Ah. An alkaline aqueous solution was used as the electrolytic solution 9. The water repellent film 6 has an area of 7×7 cm, the charging electrode 3 has a reaction surface of 7×7 cm, the anion film has an area of 9×7 cm, the metal negative electrode 4 has a reaction surface of 7×7 cm, the negative electrode case (PE bag 8) has an opening of 6.5×6.5 cm, and the air electrode 5 has a reaction surface of 6.5×6.5 cm. The spacer 10 is made of resin, in which an overall surface area is 7×7 cm, a thickness is 3 mm, a thickness of the framework 11 is 0.5 mm, and a pattern of each grid is a square of 4×4 mm. That means, the size of one grid pattern corresponds to one through hole 12. The aforementioned charging electrode 3, metal negative electrode 4, spacer 10, and air electrode 5 were laminated in this order, which was heat-sealed with the packaging material 2 to prepare Example of a metal-air battery 1.

Separately from the aforementioned Example, instead of the spacer 10, Comparative Example including a paper non-woven fabric having the same thickness as of the spacer 10 was prepared to conduct a charge/discharge measurement for the purpose of data comparison.

For measurement conditions of the charge/discharge measurement, a depth was set to 60% at a current density of 10 mA/cm², and a charge/discharge cycle including a set of one charge/discharge operation was repeated multiple times. The current density during the discharge was set to 60 mA/cm².

In Example, the voltage at 60 mA/cm² was 1.02 V, and on the other hand, in Comparative Example, the voltage at 60 mA/cm² was 0.97 V. Thus, it was confirmed that the voltage at 60 mA/cm² was improved by 0.05 V by providing the spacer 10 to the metal-air battery 1.

In Comparative Example, a discharge capacity at 60 mA/cm² in the eighth charge/discharge cycle was less than 1% of the discharge capacity in the first cycle, and, in contrast, in Example, 14 or more of charge/discharge cycles could be performed. This is because the spacer 10 was provided in Example, thereby the spaces for the electrolytic solution could be secured, so that the ion migration was not inhibited.

### Experiment 1

Next, the results of Experiment 1 in which the thicknesses of the frameworks 11 were compared will be explained with reference to FIG. 8.

FIG. 8 is a table of properties presenting results of Experiment 1.

In Experiment 1, Experimental Examples 1 to 5 having different thicknesses of the frameworks 11 were prepared. Specifically, the frameworks 11 have a thickness of 0.4 mm in Experimental Example 1, 0.5 mm in Experimental Example 2, 1 mm in Experimental Example 3, 2 mm in Experimental Example 4, and 2.1 mm in Experimental Example 5. Note that, in Experimental Examples 1 to 5, parameters other than the thickness of the frameworks 11 are common to the Example described above.

In Experiment 1, an initial discharge voltage, a number of charge/discharge cycles, breakage in assembly, and a void ratio were evaluated. The thicker the framework 11 is, the lower the void ratio of the spacer 10 viewed from the surface in contact with each electrode is, and the more hardly the ions pass through the spaces for the electrolytic solution in the spacer 10. Thereby, the internal resistance of the battery increases, resulting in decreased discharge voltage. If the frameworks 11 are too thin, the physical strength of the main body of the spacer 10 is insufficient, and therefore the battery is broken during assembly of the battery. The criterion for the termination of the charge/discharge cycle is defined as a timing at which the discharge voltage cannot exceed a predetermined value (0.8 V). Since the discharge voltage decreases as the cycle progresses, the lower the initial discharge voltage is, the smaller the number of the charge/discharge cycles is.

In Experimental Example 1, although the void ratio was high, the battery was broken during assembly, and therefore other parameters could not be evaluated. In Experimental Example 5, since the void ratio was low and the initial discharge voltage was low, the number of the charge/discharge cycles was one. According to the results of Experiment 1, the frameworks 11 preferably have a thickness of 0.5 to 2 mm.

### Experiment 2

Next, the results of Experiment 2 in which the volumes of the cells were compared will be explained with reference to FIG. 9.

FIG. 9 is a table of properties presenting the results of Experiment 2.

In Experiment 2, Experimental Examples 6 to 10 having different cell volumes were prepared. The volume of the cell is determined depending on the size of the through hole 12 and the interval between the frameworks 11 in the thickness direction. Specifically, the cell has a volume of 20 mm³ in Experimental Example 6, 30 mm³ in Experimental Example 7, 50 mm³ in Experimental Example 8, 100 mm³ in Experimental Example 9, and 150 mm³ in Experimental Example 10. Note that, in Experimental Examples 6 to 10, parameters other than the volume of the cell are common to the Example described above.

In Experiment 2, in the second cycle, the mAh, the number of the charge/discharge cycles, the void ratio, and a ratio of the thickness of the separator 7 to the grid interval were evaluated. In the spacer 10, a relative void ratio, and the ratio of the thickness of the separator 7 to the grid interval are determined depending on the volume of the cell. If the volume of the cell is small, the pattern becomes dense, and therefore the void ratio of the spacer 10 is low. Thereby, the ions hardly pass through the spaces for the electrolytic solution in the spacer 10, and therefore the internal resistance of the battery increases, resulting in decreased discharge voltage. If the volume of the cell is large, the effect of uniformly pressing the reaction surface is lowered, allowing expansion of the metal negative electrode 4 inside the voids of the frameworks 11, and therefore the number of the charge/discharge cycles decreases.

In Experimental Examples 6 and 10, the mAh in the second cycle was 300, which was lower than those of Experimental Examples 7 to 9. Furthermore, in Experimental Examples 6 and 10, the number of the cycles was two, which was less than those of the other Experimental Examples and could be judged to be difficult to recharge, considering together with the judgement of the mAh in the second cycle. From the results of Experiment 2, the cells comparted by the frameworks 11 preferably have a volume of 30 to 100 mm³. The ratio of the thickness of the separator 7 to the grid interval between the frameworks 11 is preferably 0.05 to 0.09.

### Experiment 3

Next, the results of Experiment 3 in which the thicknesses of the spacer 10 were compared will be explained with reference to FIG. 10.

FIG. 10 is a table of properties presenting the results of Experiment 3.

In Experiment 3, Experimental Examples 11 to 15 having different thicknesses of the spacer 10 were prepared. Specifically, the spacer 10 has a thickness of 1 mm in Experimental Example 11, 1.5 mm in Experimental Example 12, 3 mm in Experimental Example 13, 5 mm in Experimental Example 14, and 6 mm in Experimental Example 15. Note that, in Experimental Examples 11 to 15, parameters other than the thickness of the spacer 10 are common to the Example described above.

In Experiment 3, a ratio of the thicknesses between the spacer 10 and the metal negative electrode 4, a coulomb efficiency, and an energy density were evaluated. The coulomb efficiency refers to a ratio between a capacitance (Ah) transmitted to the battery during charge and a capacitance (Ah) discharged from the battery during discharge. The energy density refers to a ratio between a total amount of energy (Wh) charged in the battery and a weight (kg) of the battery itself. The ratio between the thicknesses of the spacer 10 and the metal negative electrode 4 was calculated in a condition that the thickness of the metal negative electrode 4 was 2 mm. The energy density is a calculated value calculated from the ratio between the thicknesses of the spacer 10 and the metal negative electrode 4.

The width of the spacer (thickness of the spacer 10) is proportional to the volume of the electrolytic solution 9 stored between the negative electrode and the positive electrode. The larger the width of the spacer is, the larger the weight of the battery is, and therefore the energy density is lowered. The metal-air battery 1 discharges electricity by a chemical reaction, and concentrations of reactants and products are changed by the discharge. This change in concentration deteriorates the battery performance such as polarization (voltage drop). Herein, the larger the volume of the electrolytic solution 9 stored between the negative electrode and the positive electrode is, the more the concentration change during discharge can be reduced, and therefore the voltage drop can be reduced, and a dischargeable capacity can be increased. That means, the coulomb efficiency proportional to the discharge capacity also increases. In addition, the thickness of the metal negative electrode 4 is proportional to the amount of the negative electrode active material. Thus, the smaller the thickness of the metal negative electrode 4 is, the lower the weight ratio of the negative electrode active material to the battery is, and therefore the energy density is lowered. That means, it is preferable that the thickness of the metal negative electrode 4 is larger and 1 mm or larger.

While the coulomb efficiencies in Experimental Examples 12 to 15 were about 80%, the coulomb efficiency in Experimental Example 11 was 17%, which was clearly lower. In addition, while the energy densities in Experimental Examples 11 to 14 were 100 Wh/kg or higher, the energy density in Experimental Example 15 was 97 Wh/kg, which was lower than a predetermined value (100 Wh/kg). The results of Experiment 3 show that the thickness of the spacer 10 is 1.5 mm or larger to 5 mm or smaller and is preferably 0.75 or more times larger than the thickness of the metal negative electrode 4.

The embodiments disclosed herein are illustrative in all respects and are not intended to be the basis for a limiting interpretation. Hence, the technical scope of the present invention is not intended to be construed based only on the embodiments described above, and is intended to be defined based on the appended claims. The present invention incorporates all variations within the meaning and the scope equivalent to those of the appended claims.

What is claimed is:

1. A metal-air battery comprising a metal negative electrode, a positive electrode, and a spacer interposed between the metal negative electrode and the positive electrode, wherein
the spacer is composed of grid-shaped frameworks extended in a three-dimensional direction, and an electrolytic solution that fills a space between the frameworks.

2. The metal-air battery according to claim 1, wherein
the spacer has a through hole that penetrates the spacer in a thickness direction in which the metal negative electrode and the positive electrode are opposed to each other.

3. The metal-air battery according to claim 2, wherein
a size of the through hole changes in the thickness direction.

4. The metal-air battery according to claim 3, wherein
the size of the through hole is smaller on the metal negative electrode side and larger on the positive electrode side.

5. The metal-air battery according to claim 1, wherein
the spacer is composed of first frameworks and second frameworks which have mutually different grid intervals, and
the grid interval between the first frameworks is twice or more integer times as large as the grid interval between the second frameworks.

6. The metal-air battery according to claim 1, wherein
the frameworks are periodically arranged in a surface direction along a surface in contact with the metal negative electrode and in the thickness direction.

7. The metal-air battery according to claim 1, wherein
the frameworks have a thickness of 0.5 to 2 mm.

8. The metal-air battery according to claim 1, wherein
a cell comparted by the frameworks has a volume of 30 to 100 mm³.

9. The metal-air battery according to claim 1, wherein
the spacer has a thickness of 1.5 to 5 mm.

10. The metal-air battery according to claim 1, wherein
the metal negative electrode has a thickness of 1 mm or larger, and
the thickness of the spacer is 0.75 or more times larger than the thickness of the metal negative electrode.

11. The metal-air battery according to claim 1, wherein
a separator is interposed between the metal negative electrode and the spacer, and
a ratio of a thickness of the separator to the grid interval between the frameworks is 0.05 to 0.09.

12. The metal-air battery according to claim 1, wherein
a surface opposed to the metal negative electrode is sandwiched by a pair of fixtures.
